(19) United States
(12) Patent Application Publication
(10) Pub. No.: US 2024/0355538 A1
(43) Pub. Date: Oct. 24, 2024

(54) THE INSULATING GAS MIXTURE FOR REPLACING SF6, AS WELL AS ITS FORMULATION METHOD AND APPLICATION

(71) Applicant: WUHAN UNIVERSITY, Hubei (CN)

(72) Inventors: Han YANG, Hubei (CN); Han LI, Hubei (CN); Xuzhu DONG, Hubei (CN); Shubo REN, Hubei (CN); Rui QIU, Hubei (CN)

(73) Assignee: WUHAN UNIVERSITY, Hubei (CN)

(21) Appl. No.: 18/537,647

(22) Filed: Dec. 12, 2023

(30) Foreign Application Priority Data
Apr. 24, 2023 (CN) 202310450803.6

(51) Int. Cl. H01F 27/32; H01B 3/56

(52) U.S. Cl. CPC H01F 27/321; H01B 3/56

(57) ABSTRACT

The invention relates to an insulating gas mixture for replacing SF₆ gas as well as its formulation method and application. The insulating gas mixture is composed of a fluorocarbon gas and a helium gas, and the formulation method includes filling the fluorocarbon gas and the helium gas in a vacuum-sealed container.

### CROSS-REFERENCE TO RELATED APPLICATION

This application claims the priority benefit of China application no. 202310450803.6, filed on Apr. 24, 2023. The entirety of the above-mentioned patent application is hereby incorporated by reference herein and made a part of this specification.

### BACKGROUND

### Technical Field

The present invention relates to the technical field of insulating gases, and particularly relates to the formulation of an environment-friendly insulating gas mixture replacing SF₆, as well as its application.

### Description of Related Art

With the development of urban construction, the promotion and application of disaster-proof transformers has become increasingly important. Among all disaster-proof transformers, Gas-Insulated Transformers have the most potential for high-voltage and large-capacity. The increase in voltage levels and capacity means higher requirements for the insulation and thermal conductivity of the gas medium, making the search for high thermal conductivity insulating gases an urgent need.

SF₆ gas is commonly used as an insulating gas in high-voltage electrical equipment due to its excellent insulation and arc extinguishing capabilities. However, it has a global warming potential (GWP) approximately 24,300 times higher than CO₂ gas, making it a potent greenhouse gas. Therefore, it is crucial to find environment-friendly alternatives as insulation mediums to replace SF₆. These alternatives should provide similar insulation performance to SF₆ while minimizing any negative impact on the environment.

As a typical representative of fluorocarbon gases, C₄F₇N (Perfluoroisobutyronitrile) gas is a new type of environment-friendly insulating gas jointly released by ALSTON company and Minnesota Mining and Manufacturing (3M) company in 2014, and research shows that the insulation strength of C₄F₇N gas is about two times that of pure SF₆ gas, while the global warming potential is about one-ninth of SF₆ gas, making it a highly promising alternative to SF₆ gas. However, the liquefaction temperature of C₄F₇N gas is high (the liquefaction temperature under atmospheric pressure is −4.7° C.), so it cannot be applied to outdoor gas-insulated power equipment alone, and it needs to be mixed with buffer gases with low liquefaction temperature. In practical engineering applications, CO₂ gas is usually chosen as buffer gas. Numerous analyses and tests have shown that when the proportion of C₄F₇N by volume in the C₄F₇N/CO₂ gas mixture is about 20%, the insulating property is comparable with SF₆ gas, and the environmental protection performance is excellent, but the thermal conductivity is significantly improved.

Therefore, it is necessary to study the formulation of environment-friendly and thermally conductive insulation mixtures by mixing fluorocarbon gases.

### SUMMARY

In order to overcome the problems of the current technology, the present invention uses helium gas as a buffer medium for fluorocarbon gas to lower the GWP and liquefaction temperature of the insulating gas mixture and improve its thermal conductivity.

In order to realize the above purpose, the present invention provides the formulation of an insulating gas mixture replacing SF₆, comprising a fluorocarbon gas and a helium gas, wherein the fluorocarbon gas can be perfluorocarbon gas or fluorocarbon-containing compound. The perfluorocarbon gases include Carbon Tetrafluoride (CF₄), Hexafluoroethane (C₂F₆), Octafluoropropane (C₃F₈), Hexafluorobutadiene (C₄F₆), Octafluorocyclobutane (c-C₄F₈), Perfluorobutane (c-C₄F₁₀), etc. The fluorocarbon-containing compounds include Perfluorinated Ketones (represented by C₅F₁₀O and C₆F₁₂O), Perfluorinated Nitriles (represented by C₄F₇N), and Hydrofluorocarbons (HFCs), Trifluoromethyl Iodide (CF₃I), Trifluoromethylsulfonyl Fluoride (CF₃SO₂F), etc.

Further, the proportion of helium gas by volume in the gas mixture is greater than or equal to 50% and less than or equal to 70%.

The present invention also provides steps for formulating the gas mixture, comprising filling a fluorocarbon gas and a helium gas into a vacuum-sealed container.

Further, the fluorocarbon gas is filled first followed by the helium gas.

Further before filling the fluorocarbon gas and the helium gas into the vacuum-sealed container, subjecting the vacuum-sealed container to an exclusion of tramp gases treatment.

Further, after charging the fluorocarbon gas and helium to obtain a gas mixture, in some cases it comprises increasing a pressure of the gas mixture.

This invention also presents the application of the insulating gas mixture mentioned above in disaster-proof transformers.

The present invention has the following advantageous effects compared to existing technologies:
(1) The insulating gas mixture of this invention has a lower Global Warming Potential (GWP) compared to SF₆ gas.
(2) The insulation strength of the insulating gas mixture of the present invention is close to that of SF₆ gas under the same inflation pressure. If it is applied as the insulation medium of a Gas-Insulated Transformer, the same insulation strength as SF₆ can be achieved by proportionally adjusting the inflation pressure.
(3) The insulating gas mixture of this invention exhibits excellent thermal conductivity. Compared to SF₆ gas, the thermal conductivity of the gas mixture can be increased by more than 20% when the insulation strength of the gas mixture is equivalent to that of SF₆ gas. Furthermore, compared to commonly used SF₆ alternative gases in engineering (such as C₄F₇N/CO₂ gas mixture), the thermal conductivity can be increased by more than 16%.
(4) The insulating gas mixture of this invention can be used as the insulation and cooling medium for Gas-Insulated Transformers, improving the heat dissipation capacity of the transformers. Moreover, it can alleviate the greenhouse effect caused by SF₆ gas leakage. It is expected to further enhance the current-carrying capacity of Gas-Insulated Transformers and has extensive application value in the field of electrical equipment.

Other features and advantages of the present invention will be explained in the subsequent description, and some of them may become apparent from the manual or be understood by carrying out the present invention. The purpose and other advantages of the present invention can be realized and obtained through the steps or test results indicated in the subsequent description and accompanying drawings.

### BRIEF DESCRIPTION OF THE DRAWINGS

FIG. 1 shows the test curve and fitting curve of the electrical discharge test results of SF₆ gas and insulating gas mixtures prepared in embodiments 2-6 at an AC voltage of 50 Hz.

FIG. 2 shows the temperature rise curve and cooling curve of the windings after filling the insulating gas mixture prepared in embodiment 1, 18% C₄F₇N and 82% CO₂ gas mixture, and SF₆ gas into the Gas-Insulated Transformer.

FIG. 3 shows the steps for formulating one kind of insulating gas mixture (C₄F₇N/He gas mixture) of this invention within a Gas-Insulated Transformer and it should be noted that the value of A₁ is less than A₂.

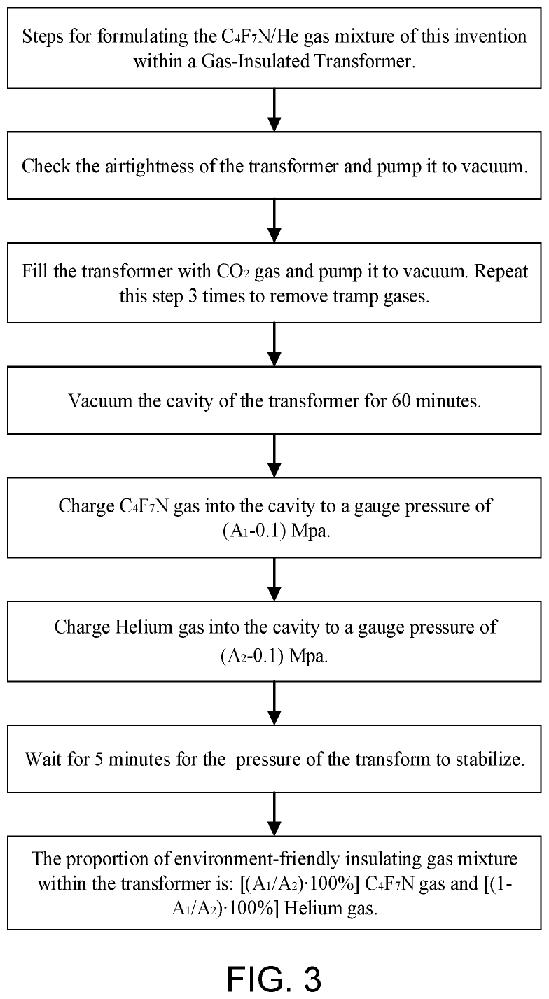

### DESCRIPTION OF THE EMBODIMENTS

The design principle of this invention resides in the fact that the Global Warming Potential (GWP) of fluorocarbon gases is generally high, while the GWP of helium gas is 0. Therefore, by controlling the proportion of helium gas and fluorocarbon gas by volume, the GWP of the insulating gas mixture can be reduced to below 2000. By adjusting the process parameters, the insulating gas mixture can achieve the same insulation performance as SF₆ without changing the design, and meet the insulation performance requirements of Gas-Insulated Transformers. Additionally, due to the excellent thermal conductivity of helium gas, using the insulating gas mixture as the cooling medium for Gas-Insulated Transformers can effectively reduce the temperature of the transformer windings and further enhance the current-carrying capacity of the Gas-Insulated Transformer.

To this end, the present invention provides the formulation of an insulating gas mixture replacing SF₆, comprising a fluorocarbon gas and a helium gas.

In the preferred embodiments of the present invention, the fluorocarbon gas is selected as C₄F₇N gas.

In one preferred embodiment of this invention, the proportion of helium gas by volume is equal to 60%. In this case, the insulating gas mixture, which replaces SF₆, can directly meet the insulation design requirements of gas transformers.

In another preferred embodiment of this invention, the proportion of helium gas by volume is equal to 70%. In this case, the insulation strength of the insulating gas mixture reaches only 80% of the insulation strength of SF₆ under the same gas pressure. However, the insulation strength of the insulating gas mixture can still be increased to be equivalent to the insulation strength of SF₆ by increasing the pressure of the gas mixture to 1.2 times the pressure of SF₆ at the same state. Therefore, without raising the proportion of Fluorocarbon gas, it is possible to meet the design requirements of gas transformer insulation by simple adjustment of air pressure.

Some embodiments of this invention set the proportion of helium gas by volume to be 60-70%, and the proportion of fluorocarbon gas by volume to be 30-40%. Such a ratio setting facilitates the technician to better implement the embodiment of the present invention without changing the parameters of the existing transformer.

In the preferred embodiments of the present invention, the proportion of helium gas by volume is greater than or equal to 50%. Through numerous experiments and data simulations, it shows that when the proportion of helium gas by volume is less than 50%, the thermal conductivity of the insulating gas mixture significantly decreases and the liquefaction temperature increases, which does not meet the design standards of gas-insulation transformers.

In one embodiment of the present invention, at an absolute pressure of 0.3 MPa, when the proportion of the fluorocarbon gas by volume is 40%, the thermal conductivity of the gas mixture is superior to that of SF₆ gas and 18% C₄F₇N/82% He gas mixture.

The present invention also provides the methods for formulating the insulating gas mixture replacing SF₆, which comprises filling a fluorocarbon gas and a helium gas into a vacuum-sealed container.

In one embodiment of the present invention, in order to have a better application of the prepared insulating gas mixture, the airtight container is selected as a transformer, and the airtightness of the transformer is qualified. Of course, the airtight container can also be selected as a gas tank or other containers, but it needs to meet the requirements of airtightness and a certain compressive strength.

In one embodiment of the present invention, the filling of the fluorocarbon gas and helium gas is further preceded by subjecting the vacuum-sealed container to an exclusion of tramp gases treatment. As an optional method, CO₂ gas can be used for gas washing treatments of the transformer's chamber and pipes to remove other tramp gases present in the chamber and pipes.

In one embodiment of the present invention, the fluorocarbon gas is filled first followed by helium gas.

In one embodiment of the present invention, after filling the fluorocarbon gas and the helium gas in the vacuum-sealed container to form a gas mixture, it also comprises increasing the pressure of the gas mixture.

The present invention also provides the application of the above-mentioned insulating gas mixture: applying it in disaster-proof transformers.

Neither the endpoints of the ranges nor any of the values disclosed in the present invention are limited to that precise range or value, and these ranges or values should be understood as including values that are close to these ranges or values. For numerical ranges, the endpoints of each range, the endpoints of different ranges and individual point values, as well as individual point values, can be combined to obtain one or more new numerical ranges. These numerical ranges should be considered specifically disclosed in this invention.

The technical solutions in the embodiments of the present invention will be described clearly and completely in the following in connection with specific embodiments of the present invention and the accompanying figures of the specification. Obviously, the described embodiments are only a part of the embodiments of the present invention, and not all the embodiments. Based on the embodiments in the present invention, all other embodiments obtained by a person of ordinary skill in the art without making creative labor are within the scope of protection of the present invention.

### Embodiment 1

A method for formulating an insulating gas mixture as a substitute for SF₆ includes the following steps:
(1) Vacuum the transformer with qualified airtightness until the pressure gauge drops to −0.1 MPa (absolute pressure 0 MPa) and continue the vacuum process for an additional 10 minutes.
(2) To remove other tramp gases in the transformer's cavity and pipeline, use CO₂ gas to flush the cavity and pipeline three times.
(3) Vacuum the cavity of the transformer for 60 minutes after gas washing. Because the saturated vapor pressure of C₄F₇N gas is low, first charge C₄F₇N gas into the cavity to a gauge pressure of 0.02 Mpa. At this point, the absolute pressure is 0.12 MPa, with the volume of C₄F₇N gas accounting for 40% of the gas mixture; and then wait for 5 minutes for the number to stabilize. After that, close the valve connecting the transformer cavity, vacuum the pipeline and then fill the cavity with helium gas until the gauge pressure is 0.2 Mpa. At this point, the absolute pressure is 0.3 MPa, with the volume of helium gas accounting for 60% of the gas mixture; and then wait for 5 minutes for the number to stabilize. After completing all the above steps, the preparation of the insulating gas mixture to replace SF₆ is completed. In the context of pressure, it is important to note that absolute pressure is the direct pressure exerted on the surface of a container or object. The value of absolute pressure is measured relative to absolute vacuum, and it represents the pressure in relation to zero pressure. Gauge pressure is that portion of the total absolute pressure that exceeds the surrounding atmospheric pressure (one atmospheric pressure is 0.1 MPa). In this step, the gauge pressure of 0.2 MPa is equal to the absolute pressure of 0.3 MPa.

### Embodiment 2˜6

The steps for formulating the insulating gas mixture replacing SF₆ is basically the same as that of Embodiment 1, with the difference being that the mixture is prepared according to the proportions of C₄F₇N gas and helium gas by volume specified in Table 1.

TABLE 1

| | The Proportion | The Proportion |
|---|---|---|
| | of C₄F₇N Gas (%) | of Helium Gas (%) |
| Embodiment 2 | 5 | 95 |
| Embodiment 3 | 15 | 85 |
| Embodiment 4 | 25 | 75 |
| Embodiment 5 | 50 | 50 |
| Embodiment 6 | 75 | 25 |
| Embodiment 7 | 30 | 70 |
| Embodiment 8 | 35 | 65 |

### Test Case

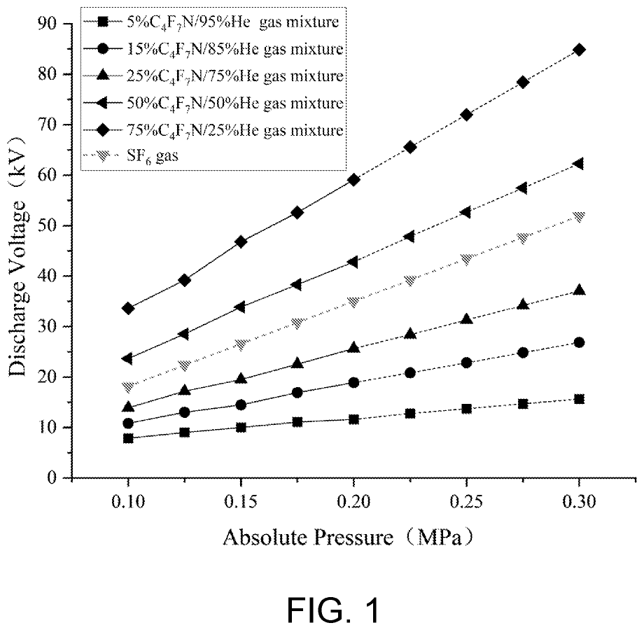

In order to investigate the insulating properties of the insulating gas mixture in this invention, it was subjected to electrical discharge test at an AC voltage of 50 Hz, and the test results were compared with those of SF₆ gas. The absolute air pressure of the test ranged from 0.1 to 0.2 MPa (common air pressure range for gas transformers). The test electrode was a ball-ball electrode with a pitch of 2.5 mm, and the electric field non-uniformity was 1.21. The procedure for performing AC electrical discharge tests on specific gas gaps follows the guidelines outlined in IEC 60243-1:2013 “Electric strength of insulating materials-Test methods-Part 1: Tests at power frequencies”. The results are shown in FIG. 1.

Under the condition of absolute air pressure of 0.1 to 0.2 MPa, the results of the electrical discharge test of the insulating gas mixture prepared in Embodiment 2 to 6 are shown in the solid line portion in FIG. 1. From the analysis of FIG. 1, when the absolute air pressure varies between 0.1 and 0.2 MPa, the insulating strength of SF₆ gas is between the insulating gas mixture with a 25% proportion of C₄F₇N by volume (Embodiment 4) and a 50% proportion of C₄F₇N by volume (Embodiment 5), and the discharge voltage of Embodiment 2-6 varies approximately linearly with the variation of pressure. By performing a linear regression on the curve of discharge voltage versus air pressure for Embodiment 2-6, the variation of the discharge voltage with air pressure when the absolute pressure is between 0.2 to 0.3 MPa can be obtained, as shown by the dashed line in FIG. 1.

Based on the discharge tests of Embodiment 2 to 6, the insulation strength of the insulating gas mixture of Embodiment 1 and Embodiment 7-8 can be extrapolated by linear fitting when the absolute air pressures are 0.1 MPa, 0.2 MPa, 0.3 MPa, and the results are shown in Table 2.

TABLE 2

| Absolute | | | | Insulation Strength Relative to SF₆ | | |
|---|---|---|---|---|---|---|
| Air | Discharge Voltage (kV) | | | Gas | | |
| Pressure | Embodiment | Embodiment | Embodiment | Embodiment | Embodiment | Embodiment |
| (MPa) | 7 | 8 | 1 | 7 | 8 | 1 |
| 0.1 | 15.85 | 17.80 | 19.75 | 87.42% | 98.18% | 108.94% |
| 0.2 | 29.07 | 32.50 | 35.94 | 83.03% | 92.83% | 102.66% |
| 0.3 | 42.10 | 47.14 | 52.18 | 81.13% | 90.85% | 100.56% |

From the analysis of the extrapolation results in Table 2, it can be concluded that the insulation strength of the insulating gas mixture of Embodiment 1 and Embodiment 7-8 can reach more than 80% of the insulation strength of SF₆ gas when the absolute gas pressure is 0.1 MPa, 0.2 MPa and 0.3 MPa. By elevating the pressure of the gas mixture to 1.2 times the pressure of the SF₆ gas in the same state, the same insulating strength as that of the SF₆ gas can be achieved, which meets the design requirements for the insulation of the Gas-Insulated Transformers.

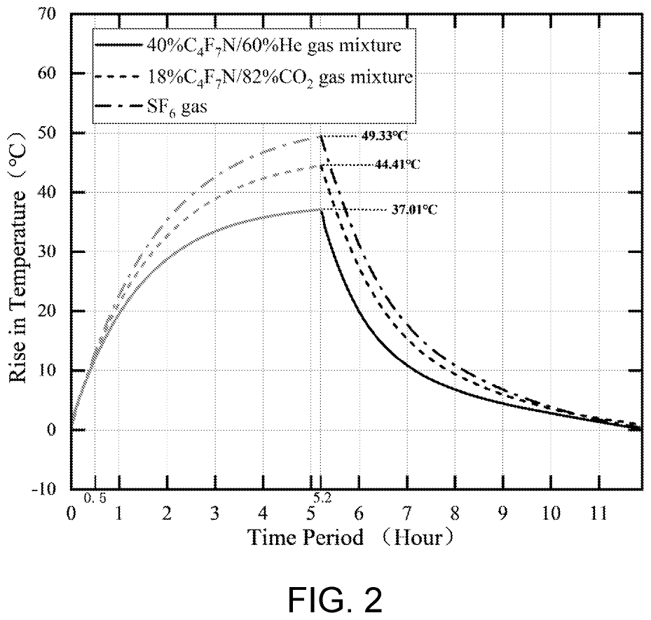

In order to study the thermal conductivity of the insulating gas mixture prepared as a substitute for SF₆ gas in this invention, it was subjected to a transformer short-circuit temperature rise test, which was carried out in accordance with IEC 60076-15:2015 “Power transformers-Part 15: Gas-filled power transformers “. The rated input voltage of the test transformer is 200V, the rated input current is 20 A, and the maximum output voltage of the test-transformer is 50 kV. The specific experimental procedure comprises filling the test transformer with SF₆ gas, 18% C₄F₇N/82% CO₂ gas mixture, and 40% C₄F₇N/60% He gas mixture (Embodiment 1) under the absolute pressure of 0.3 MPa to carry out the transformer short-circuit temperature rise test. During the test, the low-voltage input of the test transformer is connected to the high-current-output transformer, the input current is 20 A and the high-voltage output end is short-circuited. The temperature rise duration is around 5 hours, and the low-voltage input of the test-transformer is disconnected when the transformer temperature reaches a stable value. The temperature rise curve and cooling curve of the windings during the whole test are shown in FIG. 2. It should be noted that the cooling process (the descending curve) in FIG. 2 is the measured value of the temperature sensors, and the heating process (the ascending curve) is the predicted value of the Gas-Insulated Transformer thermal circuit model. Table 3 shows the average steady-state temperature rise of the Gas-Insulated Transformer windings after 5.2 hours of operation at an absolute pressure of 0.3 MPa with an input current of 20 A at the low-voltage end and a short-circuit at the high-voltage end.

TABLE 3

| Type of filling gas | 40% C₄F₇N/He | SF₆ | 18% C₄F₇N/CO₂ |
|---|---|---|---|
| Average Steady-State | 37.01° C. | 49.33° C. | 44.41° C. |
| Temperature Rise | | | |

According to the results in Table 3, under the same test conditions, the test transformer using the insulating gas mixture (with a 40% proportion of C₄F₇N gas and a 60% proportion of helium gas by volume, with insulation strength equivalent to SF₆ gas) prepared Embodiment 1 has a more than 20% lower average steady-state temperature rise of the transformer winding than the SF₆ gas-filled transformer with the same gas pressure, and has a more than 16% lower average steady-state temperature rise of the transformer winding than the 18% C₄F₇N/82% CO₂ gas-filled transformer.

Furthermore, in Embodiment 5 of the present invention, the proportion of helium gas by volume is equal to 50%, at which point the results of the transformer short-circuit temperature rise test show that the average steady state temperature rise of Implementation Embodiment 5 is increased relative to Embodiment 1, but the overall performance is still better than that of SF₆ gas at the same gas pressure. Therefore, in order to maintain the thermal conductivity of the insulating gas mixture replacing SF₆, the proportion of helium gas by volume should be greater than or equal to 50%.

In summary, the present invention introduced the formulation of an insulating gas mixture to replace SF₆ by using helium gas as a buffer medium for the C₄F₇N gas in order to lower the GWP and liquefaction temperature, and improve the thermal conductivity. When the C₄F₇N gas accounts for 30% by volume of the mixture, the insulation performance of the gas mixture can reach 80% of SF₆ gas. Furthermore, by adjusting the pressure, the insulation performance can be equivalent to SF₆ gas. When the C₄F₇N gas accounts for 40% by volume of the mixture, it can directly replace SF₆ gas to meet the insulation design requirements of Gas-Insulated Transformers. When the C₄F₇N gas accounts for 40% by volume of the mixture, the thermal conductivity of the gas mixture is superior to that of SF₆ gas and 18% C₄F₇N/82% CO₂ gas mixture at an absolute pressure of 0.3 MPa. The insulating gas mixture of the present invention can be used as the insulation and cooling medium of Gas-Insulated Transformers to improve the current-carrying capacity of the transformers and mitigate the greenhouse effect caused by SF₆ gas leakage. It has wide application value in the field of electrical equipment.

Finally, it should be noted that the above description is only the preferred embodiments of the present invention and is not intended to limit the scope of the invention. Although detailed descriptions of the embodiments have been provided, those skilled in the art can still modify the technical solutions described in the embodiments or make equivalent replacements for some technical features described therein. Any modifications, equivalent substitution, improvement, etc. made within the spirit and principles of the present invention should be included in the scope of protection of the present invention.

What is claimed is:

1. An insulating gas mixture for replacing SF₆, comprising a fluorocarbon gas and a helium gas.

2. The insulating gas mixture of claim 1, wherein a proportion of the helium gas by volume is less than or equal to 70%.

3. The insulating gas mixture of claim 1, wherein a proportion of the helium gas by volume is greater than or equal to 50%.

4. The insulating gas mixture of claim 1, wherein a formulation of the insulating gas mixture is C₄F₇N/He.

5. The insulating gas mixture of claim 1, wherein a proportion of the helium gas by volume is greater than or equal to 50% and less than or equal to 70%.

6. A method for formulating an insulating gas mixture as an alternative to SF₆, comprising filling a fluorocarbon gas and a helium gas into a vacuum-sealed container.

7. The method of claim 6, wherein the fluorocarbon gas fills in the vacuum-sealed container first and then the helium gas fills in the vacuum-sealed container.

8. The method of claim 6, wherein before filling the fluorocarbon gas and the helium gas into the vacuum-sealed container, subjecting the vacuum-sealed container to an exclusion of tramp gases treatment.

9. The method of claim 6, wherein after filling the fluorocarbon gas and the helium gas in the vacuum-sealed container to form a gas mixture, the method further comprises increasing a pressure of the gas mixture.

10. An application of an insulating gas mixture for replacing SF₆ according to claim 1 for a disaster-proof transformer.
